(19) United States
(12) Patent Application Publication
(10) Pub. No.: US 2008/0191786 A1
(43) Pub. Date: Aug. 14, 2008

(54) HIGH VOLTAGE GENERATION CIRCUIT AND METHOD FOR GENERATING HIGH VOLTAGE

(75) Inventors: Oh Suk Kwon, Yongin-si (KR); Ki Hwan Choi, Seongnam-si (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: Samsung Electronics Co., Ltd., Suwon-si (KR)

(21) Appl. No.: 11/962,479

(22) Filed: Dec. 21, 2007

(30) Foreign Application Priority Data
Feb. 12, 2007 (KR) 10-2007-0014466

(51) Int. Cl. G05F 3/02

(52) U.S. Cl. 327/536

(57) ABSTRACT

A high voltage generation circuit includes a delay circuit configured to generate multiple delay clock signals based on a clock signal. The delay clock signals include corresponding different predetermined delay times. The high voltage generation circuit further includes multiple pumps corresponding to the delay clock signals. The pumps are configured to perform a charge pumping operation in response to the corresponding delay clock signals to generate a high voltage.

### CROSS-REFERENCE TO RELATED PATENT APPLICATION

A claim of priority is made to Korean Patent Application No. 10-2007-0014466, filed on Feb. 12, 2007, the subject matter of which is hereby incorporated by reference.

### BACKGROUND OF THE INVENTION

1. Field of the Invention

The present invention relates to high voltage generation, and more particularly, to a high voltage generation circuit and a method for generating a high voltage.

2. Description of the Related Art

Semiconductor memory devices, such as NAND flash memory devices, NOR flash memory devices, and electrically erasable programmable read-only memory (EEPROM) devices, which include electrically programmable and erasable memory cells, use a high voltage higher than a normal power supply voltage in order to program or erase the memory cells.

FIG. 1 is a block diagram illustrating a conventional high voltage generation circuit 100. FIG. 2 is a graph of a high voltage VPP output from the high voltage generation circuit 100.

Referring to FIG. 1, the high voltage generation circuit 100 includes a regulator 110, a clock generator 120, and pumps 132, 134, and 136. The regulator 110 compares a voltage VS, which results from division of the high voltage VPP by voltage dividing resistors R1 and R2, with a reference voltage Vref, and generates an enable signal EN_CLK based on a result of the comparison.

The clock generator 120 generates a clock signal CLK in response to the enable signal EN_CLK. Each of the pumps 132, 134, and 136 performs a charge pumping operation in response to the clock signal CLK, thereby generating and outputting the high voltage VPP.

The pumps 132, 134, and 136 are simultaneously enabled or disabled in response to the clock signal CLK. When the pumps 132, 134, and 136 are simultaneously enabled, the time taken for the high voltage VPP to reach a target voltage is less than when only one pump is enabled. However, as the number of pumps increases, the ripple of the high voltage VPP also increases.

Referring to FIG. 2, even after the high voltage VPP reaches a target voltage VT, all of the pumps 132, 134, and 136 continue to be enabled until a predetermined time point T1 and a ripple of the high voltage VPP occurs. During a period from the time point T1 to a time point T2, the pumps 132, 134, and 136 are all disabled. During a period from the time point T2 to a time point T3, the pumps 132, 134, and 136 are all enabled.

As illustrated in FIG. 2, the ripple of the high voltage VPP repeatedly occurs on the basis of the target voltage VT. This ripple becomes greater as the number of pumps simultaneously enabled increases.

A ripple of a high voltage supplied while memory cells in semiconductor memory devices are programmed or erased may degrade the reliability of the program or erase operation. Furthermore, the ripple may cause stress on the semiconductor memory devices, thereby causing failure.

### SUMMARY OF THE INVENTION

An aspect of the present invention provides a high voltage generation circuit including a delay circuit and multiple pumps. The delay circuit is configured to generate multiple delay clock signals based on a clock signal. The delay clock signals include corresponding different predetermined delay times. The pumps, which correspond to the delay clock signals, are configured to perform a charge pumping operation in response to the corresponding delay clock signals to generate a high voltage.

The high voltage generation circuit may further include a regulator configured to generate an enable signal based on a voltage level of the high voltage, and a clock generator configured to generate the clock signal, which has an activation period which changes in response to the enable signal and an external clock signal.

The delay circuit may include multiple delay paths corresponding to the multiple delay clock signals. Each of the delay paths include at least one delay element. Each of the delay paths may also control an activation period of the corresponding delay clock signal based on the activation period of the clock signal and the predetermined delay time corresponding to each delay clock signal. Further, each of the delay paths may deactivate the corresponding delay clock signal when the activation period of the clock signal is shorter than the predetermined delay time of the corresponding delay clock signal.

Another aspect of the present invention provides a high voltage generation method. The method includes generating multiple delay clock signals based on a clock signal, the delay clock signals having corresponding different predetermined delay times; and generating a high voltage by performing charge pumping operations in response to the delay clock signals.

The method may further include generating an enable signal based on a voltage level of the high voltage and generating the clock signal, which has an activation period which changes in response to the enable signal and an external clock signal. Generating the delay clock signals may include controlling an activation period of each delay clock signal based on the activation period of the clock signal and the predetermined delay time corresponding to the delay clock signal.

### BRIEF DESCRIPTION OF THE DRAWINGS

The embodiments of the present invention will be described with reference to the attached drawings, in which:

FIG. 1 is a block diagram illustrating a conventional high voltage generation circuit;

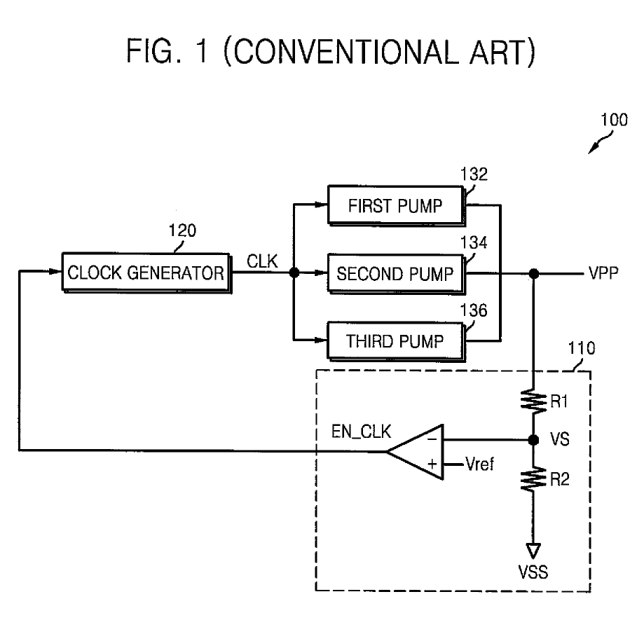

FIG. 2 is a graph illustrating a high voltage output from the high voltage generation circuit of FIG. 1;

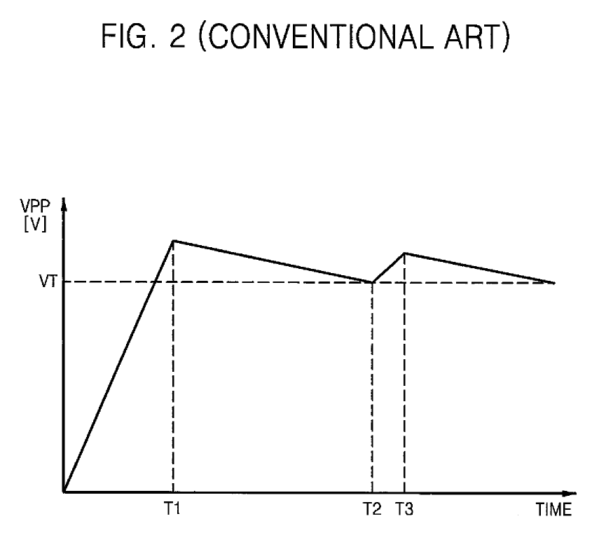

FIG. 3 is a block diagram illustrating a high voltage generation circuit, according to exemplary embodiments of the present invention;

FIG. 4 is a block diagram illustrating a clock generator of FIG. 3, according to exemplary embodiments of the present invention;

FIG. 5 is a block diagram illustrating a delay circuit of FIG. 3, according to exemplary embodiments of the present invention;

FIG. 6 is a circuit diagram illustrating a pump of FIG. 3, according to exemplary embodiments of the present invention;

FIG. 7 is a timing chart illustrating delay clock signals output from a delay circuit, according to exemplary embodiments of the present invention; and

FIG. 8 is a graph illustrating a high voltage output from a high voltage generation circuit, according to exemplary embodiments of the present invention.

### DETAILED DESCRIPTION OF THE EMBODIMENTS

The present invention now will be described more fully with reference to the accompanying drawings, in which exemplary embodiments of the invention are shown. The invention may, however, be embodied in various different forms, and should not be construed as being limited only to the illustrated embodiments. Rather, these embodiments are provided as examples, to convey the concept of the invention to one skilled in the art. Accordingly, known processes, elements, and techniques are not described with respect to some of the embodiments of the present invention. In the drawings, the size and relative sizes of layers and regions may be exaggerated for clarity. Also, throughout the drawings and written description, like reference numerals will be used to refer to like or similar elements.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as forward slash “/”.

It is understood that, although the terms first, second, etc., may be used herein to describe various elements, these elements should not be limited by these terms. These terms are used merely for purposes of distinguishing one element from another. For example, a first signal could be termed a second signal, and similarly a second signal could be termed a first signal, without departing from the teachings of the disclosure.

The terminology used herein is for the purpose of describing particular illustrative embodiments only and is not intended to be limiting of the invention. As used herein, the singular forms “a”, “an” and “the” are intended to include the plural forms as well, unless the context clearly indicates otherwise. Further, the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. Terms, such as those defined in commonly used dictionaries, should be interpreted as having a meaning that is consistent with their meaning in the context of the relevant art and/or the present application, and will not be interpreted in an idealized or overly formal sense unless expressly so defined herein.

Embodiments of the present invention provide a high voltage generation circuit and a method for providing a stable high voltage, for example, by reducing a ripple of an output voltage.

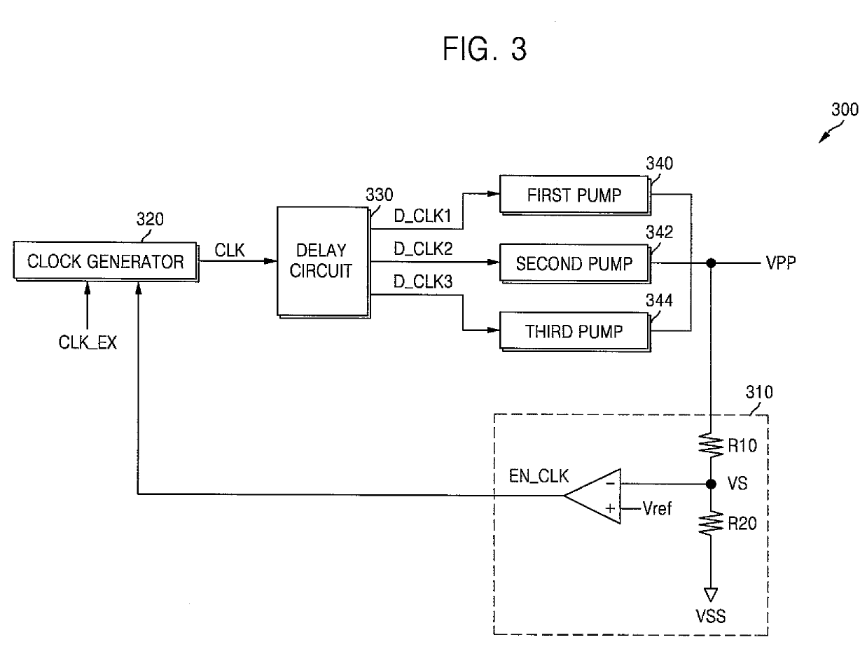

FIG. 3 illustrates a high voltage generation circuit 300 according to various embodiments of the present invention. Referring to FIG. 3, the high voltage generation circuit 300 includes a regulator 310, a clock generator 320, a delay circuit 330, and pumps 340, 342, and 344.

The regulator 310 generates an enable signal EN_CLK based on a voltage level of a high voltage VPP output from the high voltage generation circuit 300. The regulator 310 compares a sensing voltage VS, which results from division of the high voltage VPP by voltage dividing resistors R10 and R20, with a reference voltage Vref, and generates the enable signal EN_CLK based on a result of the comparison. For example, the regulator 310 may output the enable signal EN_CLK having a first logic level value (e.g., a logic value “1”) when the sensing voltage VS is lower than the reference voltage Vref, and may output the enable signal EN_CLK having a second logic level value (e.g., a logic value “0”) when the sensing voltage VS is higher than (or equal to) the reference voltage Vref.

The clock generator 320 generates a clock signal CLK having a predetermined activation period in response to the enable signal EN_CLK and an external clock signal CLK_EX. In an embodiment, the high voltage generation circuit 300 may further include an oscillator (not shown) in order to generate the external clock signal CLK_EX. The activation period of the clock signal CLK is determined by the logic level value of the enable signal EN_CLK.

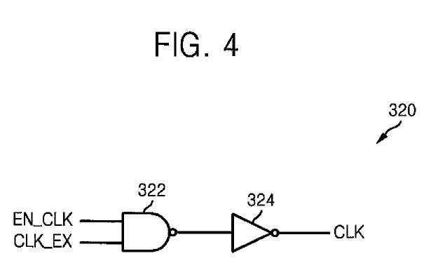

FIG. 4 illustrates an example of a clock generator 320 illustrated in FIG. 3, according to an exemplary embodiment. The clock generator 320 performs a logical operation on the enable signal EN_CLK and the external clock signal CLK_EX to generate the clock signal CLK. For instance, the clock generator 320 may include a NAND gate 322 for performing a NAND operation on the external clock signal CLK_EX and the enable signal EN_CLK, and an inverter 324 connected with an output terminal of the NAND gate 322. Accordingly, the activation period of the clock signal CLK output from the clock generator 320 is determined based on the logic value of the enable signal EN_CLK.

For example, when the enable signal EN_CLK has the first logic level value (e.g., “1”), the external clock signal CLK_EX is provided as the clock signal CLK. In other words, the clock signal CLK has the same cycle as the external clock signal CLK_EX. When the enable signal EN_CLK has the second logic level value (e.g., “0”), the clock signal CLK maintains one level value (e.g., a low level).

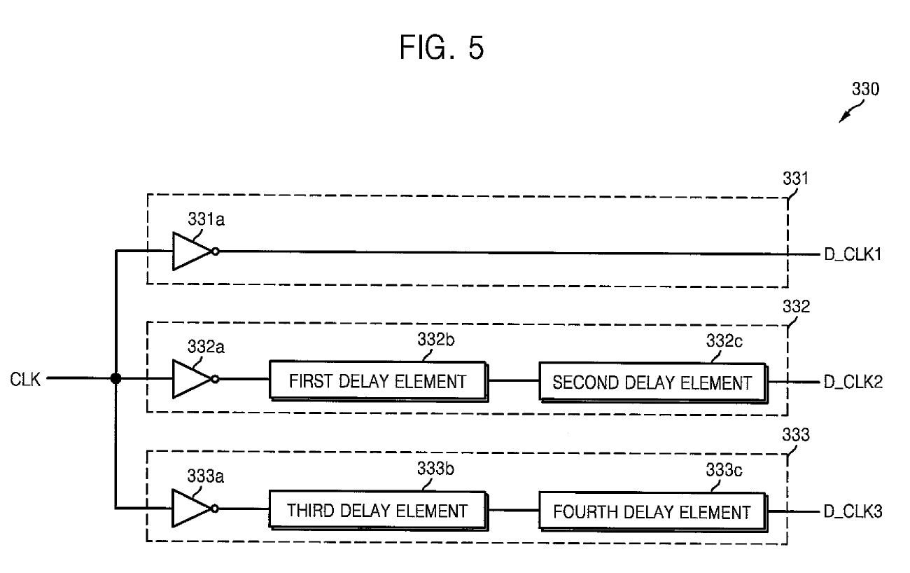

The delay circuit 330 generates multiple delay clock signals, shown as delay clock signals D_CLK1, D_CLK2, and D_CLK3, respectively having predetermined delay times based on the clock signal CLK. FIG. 5 illustrates the delay circuit 330 of in FIG. 3, according to an exemplary embodiment. Referring to FIG. 5, the delay circuit 330 includes multiple delay paths 331, 332, and 333 which respectively correspond to the first, second and third pumps 340, 342, and 344. Of course, alternative embodiments of the present invention may include more or fewer delay paths and/or corresponding delay clock signals, without departing from the spirit and scope of the present invention.

Each of the delay paths 331, 332, and 333 includes at least one element for delaying clock signal CLK. Referring to FIG. 5, for example, the first delay path 331 includes an inverter 331a. The second delay path 332 includes an inverter 332a, a first delay element 332b, and a second delay element 332c. The third delay path 333 includes an inverter 333a, a third delay element 333b, and a fourth delay element 333c.

The inverters 331a, 332a, and 333a and the delay elements 332b, 332c, 333b, and 333c may have different delay times, respectively. Accordingly, the delay paths 331, 332, and 333 may have different delay times, respectively.

Each of the delay paths 331, 332, and 333 may control an activation period of a corresponding one of the delay clock signals D_CLK1, D_CLK2, and D_CLK3 based on the activation period of the clock signal CLK and the delay time of the delay path 331, 332, or 333, respectively. For instance, each of the delay paths 331, 332, and 333 may be implemented by a clock buffer which can deactivate the corresponding delay clock signal D_CLK1, D_CLK2, or D_CLK3 when the activation period of the clock signal CLK is shorter than the delay times of the delay paths 331, 332, and 333.

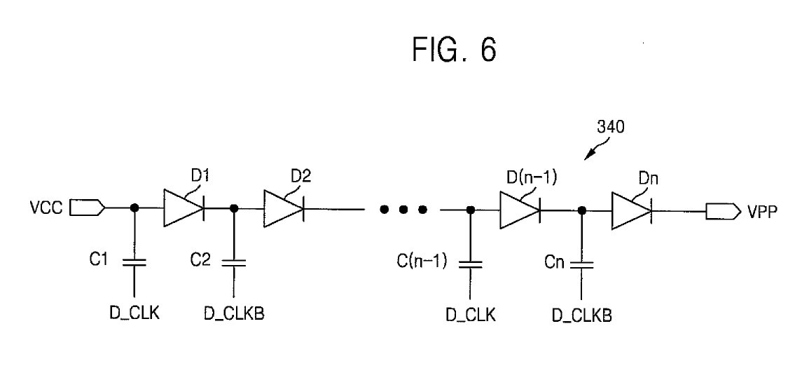

Each of the first, second and third pumps 340, 342, and 344 performs a charge pumping operation in response to a corresponding one of the delay clock signals D_CLK1, D_CLK2, and D_CLK3 to generate the high voltage VPP. FIG. 6 is a circuit diagram of the first pump 340 of in FIG. 3, according to an exemplary embodiment of the present invention.

Referring to FIG. 6, the pump 340 may include multiple diodes D1 through Dn, for example, which are connected in series between a power supply voltage line VCC and an output terminal VPP. The pump 340 also includes multiple capacitors C1 through Cn, which are respectively connected to input terminals of the respective the diodes D1 through Dn. Each of the capacitors C1 through Cn is alternately enabled with an adjacent capacitor in response to a corresponding delay clock signal D_CLK (e.g., D_CLK1 in the case of the pump 340) or a complementary delay clock signal D_CLKB. An enabled capacitor among the capacitors C1 through Cn pumps charges in order to generate the high voltage VPP.

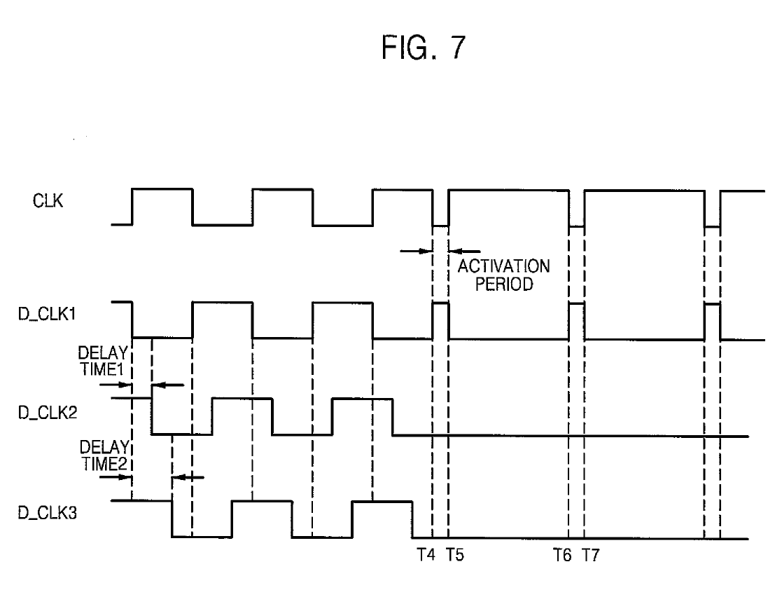

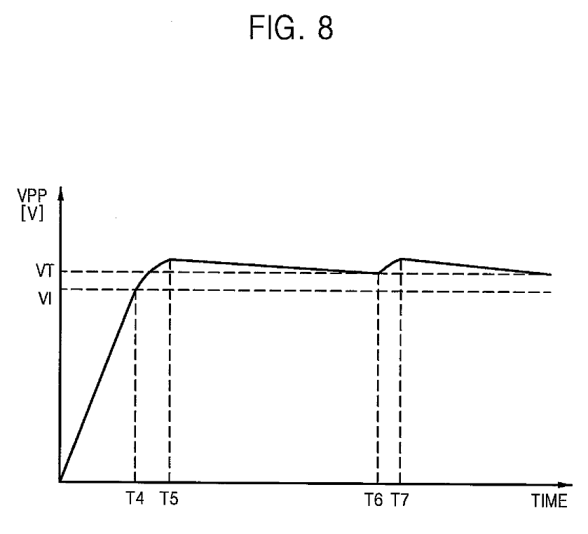

FIG. 7 is a timing chart showing examples of the delay clock signals D_CLK1, D_CLK2, and D_CLK3 output from the delay circuit 330 illustrated in FIG. 3, according to an exemplary embodiment of the present invention. FIG. 8 is a graph of the high voltage VPP output from the high voltage generation circuit 300 illustrated in FIG. 3, according to an exemplary embodiment of the present invention. Referring to FIGS. 7 and 8, the delay times of the inverters 331a, 332a, and 333a included in the delay circuit 330 illustrated in FIG. 5 are not considered, for purposes of simplifying the explanation.

Referring to FIGS. 7 and 8, at a time point T4, when the voltage level of the high voltage VPP reaches a predetermined voltage V1, the activation period of the clock signal CLK is reduced. This is because the clock signal CLK reflects the activation period of the enable signal EN_CLK output from the regulator 310.

The first delay clock signal D_CLK1 is an inverted signal of the clock signal CLK. Accordingly, in the depicted example, the delay time of the first delay clock signal D_CLK1 is 0. After the time point T4, the activation period from the time point T4 to a time point T5 of the clock signal CLK is longer than the delay time of the first delay path 331. Therefore, the first delay clock signal D_CLK1 has a certain activation period T4 to T5 and the first pump 340 performs the charge pumping operation during the activation period T4 to T5 of the first delay clock signal D_CLK1.

However, after the time point T4, the activation period of the clock signal CLK is shorter than the delay time DELAYTIME1 of the second delay clock signal D_CLK2 and the delay time DELAYTIME2 of the third delay clock signal D_CLK3. Accordingly, when each of the delay elements 332b, 332c, 333b, and 333c is implemented by a clock buffer, the second delay clock signal D_CLK2 and the third delay clock signal D_CLK3 do not have an activation period after the time point T4, which means that the second pump 342 and the third pump 344 do not perform the charge pumping operation after the time point T4. Rather, the charge pumping operation is performed only by the first pump 340 during the activation period T4 to T5, and thus the voltage level of the high voltage VPP increases at a slower rate, as shown in FIG. 8.

After the time point T5, the voltage level of the high voltage VPP lowers to a target voltage VT. The first delay clock signal D_CLK1 has another activation period from a time point T6 to a time point T7, and the first pump 340 performs the charge pumping operation during the activation period T6 to T7. However, the second delay clock signal D_CLK2 and the third delay clock signal D_CLK3 are not activated during the activation period T6 to T7 due to the respective delay times. Accordingly, the second pump 342 and the third pump 344 do not perform the charge pumping operation during the activation period T6 to T7.

Prior to the time point T4, all of the pumps 340, 342, and 344 perform the charge pumping operation in order to generate the high voltage VPP, so that the high voltage VPP is increased at a high rate. The voltage level of the high voltage VPP reaches the predetermined voltage V1 at the time point T4. However, the increase to the high voltage VPP occurs at a slower rate during the period from T4 to T5, while only the first pump 340 performs the charge pumping operation. As a result, the high voltage generation circuit 300 can output a stable high voltage with a reduced ripple. In addition, none of the pumps 340, 342, and 344 perform the charge pumping operation from the time point T5 to the time point T6. After the time point T6, only the first pump 340 is enabled during the period T6 to T7, during which the high voltage VPP is again increased slowly, and therefore, the ripple of the high voltage VPP is reduced.

When the charge pumping performance of each of the pumps 340, 342, and 344 is ramified and the delay time of each of the delay paths 331, 332, and 333 is controlled, the ripple of the high voltage VPP can be reduced further.

As described above, according to various embodiments of the present invention, a high voltage generation circuit can provide a stable high voltage with a reduced ripple by controlling an activation period of a clock signal, which controls charge pumping for the generation of the high voltage.

While the present invention has been shown and described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A high voltage generation circuit comprising:
a delay circuit configured to generate a plurality of delay clock signals based on a clock signal, the plurality of delay clock signals comprising a corresponding plurality of different predetermined delay times; and
a plurality of pumps corresponding to the plurality of delay clock signals, the plurality of pumps being configured to perform a charge pumping operation in response to the corresponding plurality of delay clock signals to generate a high voltage.

2. The high voltage generation circuit of claim 1, further comprising:
a regulator configured to generate an enable signal based on a voltage level of the high voltage; and
a clock generator configured to generate the clock signal having an activation period which changes in response to the enable signal and an external clock signal.

3. The high voltage generation circuit of claim 2, wherein the delay circuit comprises a plurality of delay paths corresponding to the plurality of delay clock signals, each of the plurality of delay paths comprising at least one delay element.

4. The high voltage generation circuit of claim 3, wherein each of the plurality of delay paths controls an activation period of the corresponding delay clock signal based on the activation period of the clock signal and the predetermined delay time corresponding to each delay clock signal.

5. The high voltage generation circuit of claim 4, wherein each of the plurality of delay paths deactivates the corresponding delay clock signal when the activation period of the clock signal is shorter than the predetermined delay time of the corresponding delay clock signal.

6. A high voltage generation method comprising:
generating a plurality of delay clock signals based on a clock signal, the plurality of delay clock signals having a corresponding plurality of different predetermined delay times; and
generating a high voltage by performing charge pumping operations in response to the plurality of delay clock signals.

7. The high voltage generation method of claim 6, further comprising:
generating an enable signal based on a voltage level of the high voltage; and
generating the clock signal, having an activation period which changes in response to the enable signal and an external clock signal.

8. The high voltage generation method of claim 6, wherein generating the plurality of delay clock signals comprises controlling an activation period of each delay clock signal based on the activation period of the clock signal and the predetermined delay time corresponding to the delay clock signal.
